(19) United States
(12) Patent Application Publication
(10) Pub. No.: US 2022/0019707 A1
(43) Pub. Date: Jan. 20, 2022

(54) METHOD FOR FORMWORK PLANNING FOR THE CONCRETING OF A CONSTRUCTION

(71) Applicant: Peri GmbH, Weissenhorn (DE)

(72) Inventor: Patrick Ksiazkiewicz, Weissenhorn (DE)

(21) Appl. No.: 17/295,373

(22) PCT Filed: Nov. 12, 2019
(86) PCT No.: PCT/EP2019/080995

§ 371 Date: May 19, 2021

(30) Foreign Application Priority Data
Nov. 19, 2018 (DE) 10 2018 129 033.0

(51) Int. Cl. G06F 30/13; G06F 30/20; G06Q 50/08

(52) U.S. Cl. CPC G06F 30/13; G06F 2111/20; G06Q 50/08; G06F 30/20

(57) ABSTRACT

A method (100) for converting a predetermined floor plan (1) into a formwork plan (2), comprising the steps of:
the predetermined floor plan (1) is provided by a user (105);
a catalogue (3, 3a-3c) is provided (110) which assigns a spatial arrangement (31b-33b) of formwork elements to a plurality of patterns (31a-33a) for courses of planned walls (11);
in areas of the given ground plan (1) in which no occurrences of patterns (31a-33a) contained in the catalogue (3, 3a-3c) have yet been found, occurrences of a pattern (31a-33a) contained in the catalogue (3, 3a-3c) are searched for (120);
for each occurrence of the pattern (31a-33a) found, the spatial arrangement (31b-33b) of formwork elements which the catalogue (3, 3a-3c) assigns to the pattern (31a-33a) is added (130) to the formwork plan (2);
it is checked (150) whether the specified floor plan (1) has been completely processed;
in response to the fact that the given floor plan (1) has not been completely worked through, a check (160) is made to see whether the catalog contains further patterns (31a-33a) which have not yet been searched for in the given floor plan (1);
in response to the fact that the catalogue (3, 3a-3c) contains such further patterns (31a-33a), one of these further patterns (31a-33a) is used to branch (170) back to the search (120) in the part of the given floor plan (1) which has not yet been processed.

### REFERENCE TO RELATED APPLICATIONS

This application claims priority to German Patent Application No. 10 2018 129 033.0, filed Nov. 19, 2018, which is incorporated herein by reference in its entirety.

The invention relates to formwork used in fabrication of a structure by pouring concrete.

### STATE OF THE ART

When a structure is built by concreting, a formwork is usually used as a casting mould for the fresh concrete. In this process, the structure is often not produced “from one pour”, but in specific construction stages, which are also called working cycles. Usually, the formwork for a working cycle is assembled, filled with concrete and removed again after the concrete has set. While the concrete of one working cycle is setting, and/or afterwards, the formwork for the next working cycle is mounted.

In order to be able to produce a formwork quickly and to be able to reuse the material many times, formwork systems consisting of prefabricated standard elements are used. An exemplary formwork system of this type is known from WO 2005/040 525 A1.

Usually, the work cycles and the formwork to be assembled for the individual work cycles are planned on the basis of a floor plan of the structure to be built.

### OBJECT AND SOLUTION

An object of the present invention is to provide a method by which the planning of formwork can be simplified on the basis of a predetermined ground plan and at the same time the quality of the result obtained can be improved.

This object is solved according to the invention by a method according to the main claim and by a computer program. Further advantageous embodiments result from the subclaims referring back thereto.

### DISCLOSURE OF THE INVENTION

In the context of the invention, a method for converting a given floor plan into a formwork plan has been developed. This formwork plan is a plan for the assembly of formwork elements for at least one working cycle of the construction of a structure corresponding to the floor plan by concreting.

In the method, the predetermined floor plan is provided by a user. This can be done in any way, such as by mouse, by touch input, by analysis of a photograph or other image document, and/or by import from a CAD application. Mixed forms are also possible. For example, on a display device, such as a monitor or a display of a tablet computer, the user may place a PDF document or a photograph of a hard copy floor plan in the background and draw the floor plan therefrom.

A catalogue is provided which assigns a spatial arrangement of formwork elements to a plurality of patterns for courses of planned walls, with which this course can be introduced into the structure to be built by concreting.

In areas of the given floor plan where no occurrences of patterns contained in the catalogue have been found yet, occurrences of a pattern contained in the catalogue are searched for. For each occurrence of the pattern found, the spatial arrangement of formwork elements that the catalog assigns to the pattern is added to the formwork plan.

Any area of the given floor plan that has already been identified as corresponding to a pattern contained in the catalog can be considered as processed. This means that a formwork solution has already been found for this area of the floor plan and this area no longer needs to be searched for further patterns. The accounting of which areas of the floor plan have already been processed can be kept in any way. For example, the presence of a spatial arrangement of formwork elements in the formwork plan indicates that the corresponding area of the floor plan has already been processed. However, each processed area of the floor plan can also be marked as processed in a representation of this floor plan.

After all occurrences of the pattern have been processed, it is checked whether the specified floor plan has been completely processed. If this is not the case, i.e. if the formwork plan is not yet complete, the system checks whether the catalog contains further patterns that have not yet been searched for in the specified floor plan. If this is the case, one of these further patterns is used to branch back to the search in the part of the specified floor plan that has not yet been processed.

It was recognized that in this way the planning of formwork can be significantly simplified. In particular, the requirements for the qualification of persons carrying out the planning are reduced.

The skilled person who has a given floor plan in front of him and knows the available standard elements of the formwork system is usually able to translate each floor plan into at least one configuration of the standard elements and, if necessary, to supplement these with formwork that is individual to this structure. He is therefore able to produce the structure by concreting, starting from the floor plan. However, it has been shown that a formwork for a given working cycle with a given ground plan can be produced with many different configurations of the standard elements. After concreting and removing the formwork, each produces essentially the same end result, but some configurations are better than others with respect to the requirements imposed on the construction process. For example, the possible configurations may differ in that,
how many formwork elements have to be moved during assembly, for example by crane,
how many different formwork elements have to be kept on site,
how long the assembly of the formwork takes in total, and/or
how high the total cost of the formwork is.

These goals can be quite contradictory. For example, having a large stock of formwork elements on site allows many different configurations to be assembled quickly at the cost of tying up capital and taking up space on site.

In the experience of the notifying party, expertise has developed over many years as to which spatial arrangement of formwork elements is most sensible for the shuttering of certain wall courses with regard to certain optimization objectives. For a given wall course, for example, there is a first spatial arrangement which is quickest to assemble, a second spatial arrangement which gets by with the smallest number of different parts, and a third arrangement whose assembly gets by with the smallest number of material movements. By retrieving the corresponding arrangement from the catalogue and adding it to the formwork plan, said expertise is made available for the at least partially automated creation of a formwork plan.

This at least partially automated creation can also be carried out in particular by persons on site who have the basic knowledge to find any suitable configuration of the formwork elements, but not the aforementioned expertise to find the optimum configuration. For example, it may be necessary to change the planned floor plan at short notice due to complications of any kind, which would render the formwork plan obsolete.

Also, for example, the optimization goal on which the original formwork plan was based can be replaced by a new one. If, for example, the original planning was based on the premise that the overall costs should be minimized, the new situation may suddenly arise that the construction project has fallen behind schedule due to weather conditions, for example, and a work cycle must be completed as quickly as possible without regard to the costs. Weather dependency is a factor that fundamentally limits planning reliability in construction. With the automated procedure described here, it is possible to change the optimization target at short notice at any time by exchanging the catalog used for one directed at the new optimization target.

In a particularly advantageous embodiment, the catalog is thus selected from a plurality of catalogs, and these catalogs differ with respect to the optimization objectives with respect to which the spatial arrangements of formwork elements contained in them are optimized.

The described procedure is iterative, i.e. when all occurrences of a pattern have been processed, occurrences of the next pattern contained in the catalog are searched for. This procedure is particularly advantageous if there is an offset between spatial arrangements of formwork elements in the formwork plan. For example, the catalog can start with patterns and corresponding spatial arrangements of formwork elements that relate to certain fixed situations. This can be followed in the catalog, for example, by patterns and corresponding spatial arrangements with which an offset between the already planned spatial arrangements can be completely or partially compensated.

At the end of the procedure, ideally, the given floor plan is completely worked off, i.e., completely translated into a formwork plan. However, this is not necessary for the beneficial effects mentioned. The simplification and the quality improvement with regard to the optimization goals pursued according to the catalog also occur if only a part of the floor plan can be automatically converted into a formwork plan and, for example, individual formwork is necessary for a special structure that cannot be realized with prefabricated formwork elements.

Advantageously, the pattern contained in the catalog is rotated and/or scaled during the search in the predetermined floor plan. Then, in response to finding occurrences of the rotated and/or scaled pattern in the predetermined floor plan, the spatial arrangement of formwork elements added to the formwork plan is rotated and/or scaled accordingly. For most of these spatial arrangements, the qualitative behavior does not change with respect to the respective optimization goals. Thus, the catalog does not have to be inflated by many rotated and/or scaled copies of patterns of the same nature, or spatial arrangements of the same effect.

Whether, for example, a left-hand corner and a right-hand corner of a structure are technically equivalent in this way and can thus be represented in the catalogue by a single generic corner may depend, for example, on a modular system used for the formwork. This modular system may also specify, for example, the extent to which the spatial arrangements of formwork elements are each physically rotatable and/or scalable.

Advantageously, the catalogue includes at least changes of direction and/or branching of walls as patterns. With these elements, the majority of common floor plans can be covered. Straight walls can optionally also be included in the catalogue.

However, they can also be added, for example, in a later working phase in the formwork plan between the spatial arrangements of formwork elements already provided there. This process is also called closing or gap filling (GAP).

In a particularly advantageous embodiment, the catalogue comprises at least rectangular or at other angles running changes of direction of walls, intersections of walls, T-shaped branches of walls, and/or curved walls with constant radius of curvature, as patterns. Especially in the case of these elements, it makes a particularly large difference with regard to typical optimization goals whether they are realized with the best or with the worst of the basically suitable spatial arrangements of formwork elements. As far as curved walls do not appear in the catalogue, they can also be added later in the formwork plan, for example, within the framework of the mentioned closing or gap-filling.

In a further particularly advantageous embodiment, changes in direction and/or branches of walls are first searched for in the floor plan. Only then are straight walls searched for. In this way, it is achieved that those elements of the floor plan are worked through first, in the realization of which the most can be done wrong without the expertise contained in the catalog. In particular, the tendency is counteracted that by working off a straight wall in the floor plan the recognizability of a not yet worked off change of direction and/or branching in the floor plan is worsened.

In a particularly advantageous embodiment, a predefined floor plan is provided which contains predefined construction joints (Taktfugen). These joints separate successive construction sections of the structure to be built and can be set in the floor plan by the user, for example, with the mouse or by touch input. The joints can, for example, be statically motivated in that certain structures that are important for the statics of the building should not be interrupted by a joint. However, the construction joints can also be motivated, for example, by work scheduling, such as by the maximum formwork area that can be worked in a certain time or by the amount of concrete available per working cycle, as well as by aesthetic aspects, for example.

In particular, the quantity of concrete available per working cycle is often a hard constraint, and there is no practical option to procure a required additional quantity at short notice. If a working cycle is then planned in such a way that the available quantity of concrete is insufficient, the working cycle cannot be realized “in one pour” because the formwork cannot be completely filled with concrete. If, however, the missing concrete is added later, the concrete added earlier has already partially or completely set. This creates a boundary surface in the component between areas where the setting of the concrete has progressed to different degrees. Such interfaces should be avoided, as they can lead to a structural weakening of the component.

In order to automatically intercept such planning errors, in a further particularly advantageous embodiment the amount of concrete and/or wall length required for realization is calculated from the floor plan for at least one working cycle and compared with a predetermined threshold value. In response to the predetermined threshold value being exceeded, a warning is issued to the user, and/or a suggestion is made to the user for an offset of at least one construction joint. This suggestion is such that, if accepted by the user, the predetermined threshold is no longer exceeded. The wall length is a further boundary condition in that, if the wall is too long, there is a tendency for cracks to form due to the shrinkage of the concrete as it sets and measures are required to limit the width of the cracks.

As a result of the subdivision into working cycles, separate formwork plans can be created for these working cycles in particular. This takes account of the condition that the walls planned as part of a working cycle should not extend over a construction joint.

In a further advantageous embodiment, in response to the fact that the predetermined floor plan has not been completely processed and the catalog does not contain any further patterns which have not yet been searched for in the predetermined floor plan, it is checked whether at least one area of the floor plan which has not yet been processed contains at least one construction joint. If this is the case, this area is searched for patterns from the catalog, hiding the clock pulse. This means that during this search, the system pretends that the pour joint does not exist.

Now, if a pattern is found during this search, it means that the construction joint has been set unfavourably by the user in the sense that it breaks the pattern. The requirement to end a working cycle in the middle of the pattern and to continue working there later conflicts with the requirement to form a structure corresponding to the pattern in accordance with the spatial arrangement of formwork elements provided in the catalog for this pattern. The construction joint will most likely run through the middle of a formwork element.

Therefore, in such a case, at least one construction joint in the planned floor plan is moved and/or rotated in such a way that it no longer breaks the pattern found, and/or a prompt is issued to the user to move the construction joint in this way. Usually, the user has not deliberately placed the construction joint in such a way that it breaks one of the patterns in the catalog, but this has happened unintentionally because the user cannot keep all these patterns in mind.

As previously explained, the beneficial effects of the method already occur when a formwork plan can be automatically generated for only a part of the specified floor plan. However, the effects become stronger the larger this part is in relation to the complete floor plan.

Furthermore, the effectiveness of the method is not diminished by the fact that the formwork plan created in the course of the method may subsequently be completed by the drawing or closing of gaps described, or by the fact that accessories and/or connecting means may still be placed in further downstream steps.

The catalogues used in the process may, for example, be stored on a mobile device, such as a tablet, at the construction site. However, the predetermined floor plan can also be transmitted to a server, for example, and the processing of the floor plan can be performed on this server.

In a further particularly advantageous embodiment, the formwork plan is converted into an order list for formwork elements by comparison with a list of orderable formwork elements. In this way, the procurement of the materials required for the formwork according to the formwork plan is simplified and, in particular, transmission errors are avoided. In particular, the order list can be a maximum list that specifies the maximum number of components that are required simultaneously on the construction site.

There does not always have to be a 1:1 assignment between the formwork elements provided according to the formwork plan and the ordered formwork elements. In a further particularly advantageous embodiment, it is checked whether there is an alternative formwork element for two or more formwork elements in the order list which fulfils the same function. If this is the case, the alternative formwork element takes the place of the previously provided two or more formwork elements.

As described above, the formwork plan is created iteratively by successively searching for the occurrences of different patterns from the catalog in the given floor plan and by adding a spatial arrangement of formwork elements according to the catalog to the formwork plan in each case. One and the same formwork element can occur in several spatial arrangements, so that, for example, when several arrangements are placed next to each other, each containing a straight formwork element of 3 m length, two identical straight formwork elements of 3 m length are next to each other in the final formwork plan. If a straight formwork element of 6 m length is now available, it is advantageous to use this instead of the formwork elements of 3 m length. This means that less material has to be moved during assembly, and fewer connections between formwork elements have to be made and then later undone. As a result, working time is saved.

The invention also relates to a method of manufacturing a structure. In this method, a formwork plan produced by the previously described method is provided. A spatial arrangement of formwork elements conforming to the formwork plan is produced. A cavity defined by this spatial arrangement is filled with a concrete. With this method, the structure can be erected, for example, more quickly, more cheaply and/or with fewer material movements, depending on the optimization objective on which the creation of the formwork plan was based.

In particular, the method may be executed on a computer, and/or on a mobile device, for example on a tablet computer or smartphone on site at a construction site. It may thus be embodied in software that provides the computer, or mobile device, with the ability to perform the automatic formwork planning. Therefore, the invention also relates to a computer program comprising machine-readable instructions which, when executed on a computer, and/or on a mobile device, cause the computer, and/or the mobile device, to perform the described procedure. Similarly, the invention also relates to a machine-readable data carrier or download product comprising the computer program.

### SPECIAL DESCRIPTION PART

Hereinafter, the subject matter of the invention will be explained with reference to figures without limiting the subject matter of the invention herein. It is shown:

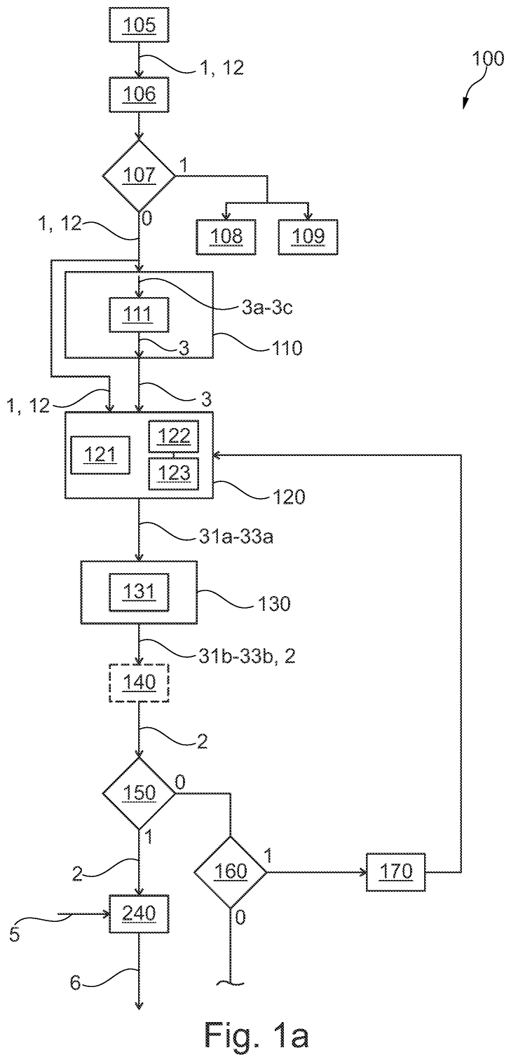

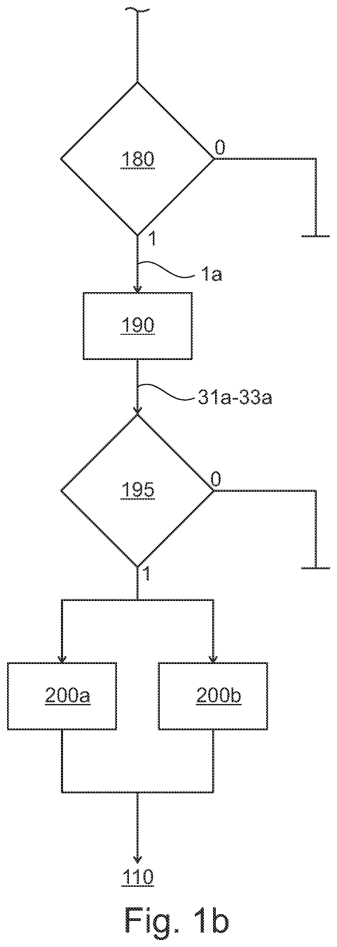

FIG. 1: Example of embodiment of the process 100;

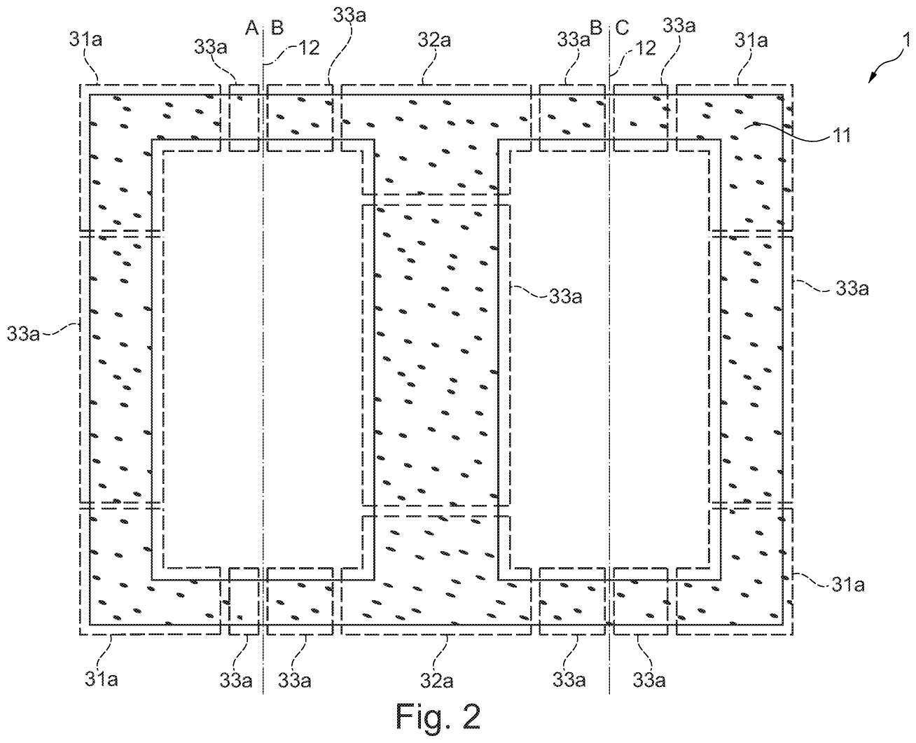

FIG. 2: Exemplary processing of a floor plan 1 with conveniently placed construction joints 12;

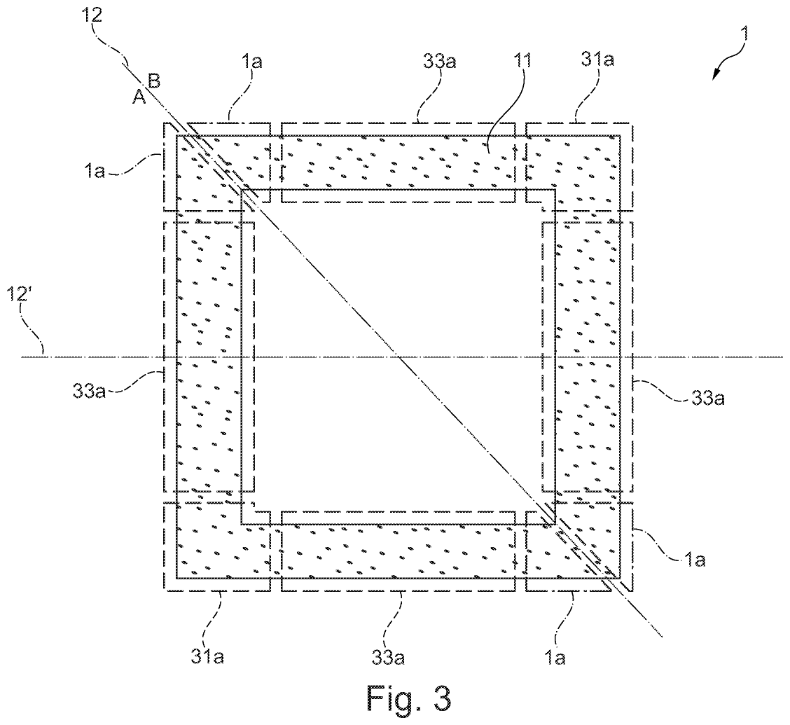

FIG. 3: Example of processing a floor plan 1 with awkwardly placed construction joints 12;

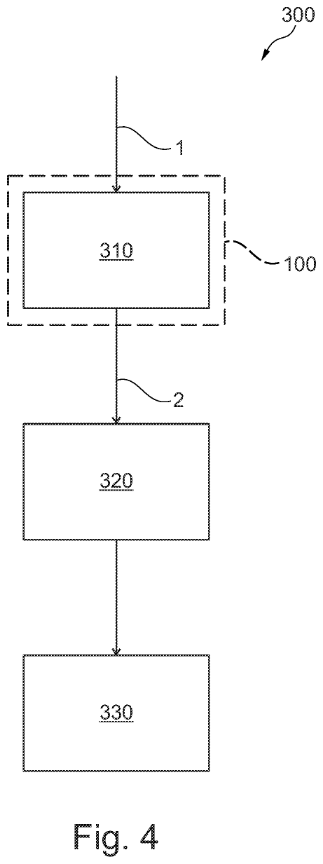

FIG. 4: Example of embodiment of process 300.

FIG. 1 shows an embodiment of the method 100. In step 105, the predetermined floor plan 1 is provided by the user, in this case including one or more construction joints 12. In step 106, the amount of concrete and/or wall length required for the realization of each cycle is calculated, and this required amount of concrete and/or wall length is compared with a predetermined threshold value in step 107. If the threshold value is exceeded (truth value 1), a warning is issued to the user in step 108, and/or a suggestion is made to the user in step 109 for a displacement of at least one construction joint 12 in such a way that, when this suggestion is implemented, the predetermined threshold value is no longer exceeded.

In step 110, catalogue 3 is provided associating patterns 31a-33a for courses of planned walls 11 respectively with a spatial arrangement 31b-31b of formwork elements. According to block 111, this catalogue 3 may be selected, for example, from a plurality of catalogues 3a-3c, depending on the optimization objective pursued in the creation of the formwork plan 2.

In step 120, occurrences of patterns 31a-33a from the catalog 3 are searched for in the floor plan 1. In doing so, these patterns may be rotated and/or scaled according to block 121. Alternatively or also in combination, according to block 122 first changes of direction and/or branches of walls may be searched for, before subsequently straight walls are searched for according to block 123. As described above, however, straight walls can also be added subsequently, for example in the course of drawing or closing gaps.

In step 130, for each occurrence of a pattern 31a-33a, the spatial arrangement 31b-33b of formwork elements associated according to catalogue 3 is added to the formwork plan 2. In doing so, the spatial arrangement 31b-33b is optionally rotated and/or scaled in the same manner as was done with the pattern 31a-33a. The occurrence of the pattern may optionally be marked as processed in a representation of the floor plan 1 at step 140. As previously described, however, this is not obligatory, because the fact that formwork elements are planned at a certain position in the formwork plan 2 already indicates that a part of the floor plan 1 corresponding thereto has been processed.

In step 150 it is checked whether the given floor plan 1 is completely processed. If this is the case (truth value 1), the formwork plan 2 is converted into an order list 6 for formwork elements in step 240 by comparison with a list 5 of orderable formwork elements. This can be, as previously described, in particular a maximum list.

If the given floor plan 1 has not been completely processed (truth value 0), a check is first made in step 160 as to whether the catalog 3 contains further patterns 31a-33a which have not yet been searched for in the given floor plan 1. If this is the case (truth value 1), one of these further patterns 31a-33a is used to branch back to search 120.

If, on the other hand, there are no more patterns 31a-33a which have not yet been searched for, then it is checked in step 180 whether a construction joint 12 divides an area 1a of the floor plan 1 which has not yet been processed. If this is the case (truth value 1), then the area 1a is examined for patterns 31a-33a in step 190 while hiding the construction joint 12. In step 195, it is checked whether a pattern 31a-33a has been found. If one was found (truth value 1), the awkwardly set clock groove 12 was responsible for the pattern 31a-33a not being detected. It is then possible, in step 200a, to automatically offset and/or rotate the construction joint 12 so that it no longer breaks the found pattern 31a-33a, i.e. so that the wall course can be produced “from one cast” in accordance with this pattern 31a-33a. Alternatively, or in combination, the user may be prompted to make such a change to the construction joint at step 200b. The creation of the formwork plan 2 can then be started again from step 110.

FIG. 2 shows a simple exemplary floor plan 1 with planned walls 11. The floor plan 1 is divided into three working cycles A, B and C by two construction joints 12. This means that separate formwork plans 2 are required for each of the three working cycles A, B and C. The formwork plans 2 for each of the three working cycles A, B and C are shown in FIG. 2. The walls planned for each working cycle A, B and C end at the construction joints 12 and 13 respectively, which limit this working cycle.

The catalogue 3 used in this simple example includes three patterns for courses of planned walls 11, namely right-angled changes of direction 31a of walls 11, T-shaped branches 32a of walls 11, and straight pieces 33a of walls 11.

When converting the floor plan 1 into a formwork plan 2 for each working cycle A, B and C, the occurrences of right-angled direction changes 31a in the floor plan 1 are searched for first. In the first working cycle A and in the third working cycle C there are two such occurrences each, in the second working cycle none. The spatial arrangements 31b of formwork elements assigned to the right-angled directional changes 31a according to the catalogue 3 are added to the respective formwork plans 2 for the working cycles A, B and C. The spatial arrangements 31b of formwork elements assigned to the right-angled directional changes 31a according to the catalogue 3 are added to the respective formwork plans 2. The right-angled directional changes 31a are thus processed, which is indicated by their dashed drawing in the floor plan 1.

Next, the occurrences of T-shaped branches 32a in the floor plan 1 are searched. Here, there are only two occurrences in the second working cycle B; none in the first working cycle A and none in the third working cycle C. To the respective formwork plans 2 for the working cycles A, B and C are added the spatial arrangements 32b of formwork elements assigned to the T-shaped branches 32a according to catalogue 3. The T-shaped branchings 32a are thus worked off, again indicated by dashed drawing in the ground plan 1.

Finally, the occurrences of straight wall pieces 33a in the floor plan 1 are searched for. Here, there are three occurrences in the first working cycle A, four in the second working cycle B and three again in the third working cycle C. To the respective formwork plans 2 for the working cycles A, B and C are added the spatial arrangements 33b of formwork elements assigned to the straight wall pieces 33a according to catalogue 3. The straight wall sections 33a are thus completed, again indicated by a dashed drawing in the floor plan 1.

In this simple example, floor plan 1 has thus been completely worked through and transferred to formwork plans 2 for the individual working cycles A, B and C.

In the example shown in FIG. 2, the catalogue 3 contains only one copy each of the right-angled change of direction 31a, the T-shaped branch 32a and the straight wall piece 33a. For the search of occurrences in the floor plan 1, these elements are each suitably scaled and/or rotated.

FIG. 3 shows another simple example of a floor plan 1 which is divided into two working cycles A and B by a construction joint 12. In this example, however, the manual placement of the construction joint 12 is inconveniently chosen, since in the upper left corner and in the lower right corner of the floor plan the planned wall 11 ends at the construction joint 12 in a slope, respectively, which does not occur in the catalogue 3 as pattern 31a-33a. Accordingly, after the detection of the rectangular directional changes 31a and the straight wall portions 33a shown in FIG. 3, there remain areas 1a of the floor plan 1 that have not yet been worked through. One embodiment of the method 100 provides for moving and/or rotating the construction joint 12, and/or prompting the user to make such a change. For example, if the construction joint 12 is changed to the construction joint 12′, the same catalogue 3 of patterns 31a-33a can be used to process the entire floor plan 1, as in FIG. 2.

FIG. 4 shows an example of an embodiment of the method 300 for the construction of a building. In step 310, at least one formwork plan 2 is created from the planned floor plan 1 in accordance with the method 100. In step 320, a spatial arrangement of formwork elements conforming to this formwork plan 2 is produced. In step 330, a cavity defined by this spatial arrangement is filled with a concrete.

### LIST OF REFERENCE SIGNS

1 planned floor plan
1a unfinished part of floor plan 1
11 planned wall layout in floor plan 1
12 construction joint in plan view 11
2 formwork plan
3 catalogue with patterns 31a-33a and spatial arrangements 31b-33b
3a-3c catalogues with different optimisation targets
31a-33a patterns for courses of planned walls 11
31b-33b spatial arrangements of formwork elements
5 list of formwork elements that can be ordered
6 order list
100 method for formwork planning
105 providing the floor plan 1
106 calculating the quantity of concrete per working cycle
107 check whether concrete quantity exceeds threshold value
108 issue a warning to the user
109 submitting a proposal to the user
110 providing catalog 3
111 selecting catalogue 3 from several catalogues 3a-3c
120 searching for occurrences of a pattern 31a-33a in floor plan 1
121 rotate and/or scale pattern 31a-33a
122 searching for changes of direction and branches
123 search for straight walls
130 add spatial arrangement 31b-33b according to pattern 31a-33a
131 rotating and/or scaling the assembly 31b-33b
140 mark pattern 31a-33a as completed
150 check whether floor plan 1 has been completely processed
160 check whether samples 31a-33a not yet searched exist
170 continue search 120 with new pattern
180 check whether construction joint 12 in unprocessed area 1a
190 searching for pattern 31a-33a with fade out of construction fugue 12
195 testing whether samples 31a-33a found
200a shifting and/or rotating the construction joint 12
200b request the user to change the construction joint 12
240 converting the formwork plan 2 into an order list 6
300 method for the construction of a building
310 providing the formwork plan 2
320 creating the spatial arrangement of formwork elements
330 filling the cavity of the spatial arrangement with concrete
A, B, C working cycles

1. Method (100) for converting a predetermined floor plan (1) into a formwork plan (2) for assembling formwork elements for at least one working cycle (A, B, C) of the construction of a structure corresponding to the floor plan (1) by concreting, comprising the steps:
the predetermined floor plan (1) is provided by a user (105);
a catalogue (3, 3a-3c) is provided (110) which assigns to a plurality of patterns (31a-33a) for courses of planned walls (11) in each case a spatial arrangement (31b-33b) of formwork elements with which this course can be included, by concreting, into the structure to be produced;
in areas of the given ground plan (1) in which no occurrences of patterns (31a-33a) contained in the catalogue (3, 3a-3c) have yet been found, occurrences of a pattern (31a-33a) contained in the catalogue (3, 3a-3c) are searched for (120);
for each occurrence of the pattern (31a-33a) found, the spatial arrangement (31b-33b) of formwork elements which the catalogue (3, 3a-3c) assigns to the pattern (31a-33a) is added (130) to the formwork plan (2);
it is checked (150) whether the specified floor plan (1) has been completely processed;
in response to the fact that the given floor plan (1) has not been completely worked through, a check (160) is made to see whether the catalog contains further patterns (31a-33a) which have not yet been searched for in the given floor plan (1);
in response to the fact that the catalogue (3, 3a-3c) contains such further patterns (31a-33a), one of these further patterns (31a-33a) is used to branch (170) back to the search (120) in the part of the given floor plan (1) which has not yet been processed.

2. Method (100) according to claim 1, wherein the catalogue (3) is selected (111) from a plurality of catalogues (3a-3c) that differ with respect to the optimization objectives with respect to which the spatial arrangements (31b-33b) of formwork elements contained therein are optimized.

3. Method (100) according to any one of claims 1 to 2, wherein the pattern (31a-33a) is rotated and/or scaled (121) in the search (120), and wherein in response to finding occurrences of the rotated and/or scaled pattern (31a-33a) in the predetermined floor plan (1), the spatial arrangement (31b-33b) of formwork elements added to the formwork plan (2) is rotated and/or scaled (131) accordingly.

4. Method (100) according to any one of claims 1 to 3, wherein the catalogue (3, 3a-3c) comprises at least directional changes and/or branching of walls as patterns (31a-33a).

5. Method (100) according to claim 4, wherein the catalogue (3, 3a-3c) comprises at least rectangular or at other angles changes of direction of walls, crossings of walls, T-shaped branches of walls, and/or curved walls with constant radius of curvature, as patterns (31a-33a).

6. Method (100) according to any one of claims 4 to 5, wherein in the floor plan (1) first changes of direction and/or branches of walls are searched (122) and thereafter straight walls are searched (123).

7. Method (100) according to any one of claims 1 to 6, wherein a predetermined floor plan (1) is provided (105) comprising predetermined construction joints (12), said construction joints (12) separating successive construction sections to be concreted of the structure to be constructed.

8. Method (100) according to claim 7, wherein the quantity of concrete and/or wall length required for realization is calculated (106) from the floor plan (1) for at least one working cycle (A, B, C), wherein the required quantity of concrete and/or wall length is compared (107) with a predetermined threshold value and wherein, in response to the predetermined threshold value being exceeded, a warning is output (108) to the user and/or a suggestion is made (109) to the user for a displacement of at least one construction joint (12) in such a way that the predetermined threshold value is no longer exceeded.

9. Method according to any one of claims 7 to 8, wherein a separate formwork plan (2) is prepared for each working cycle (A, B, C).

10. Method (100) according to any one of claims 7 to 9, wherein in response to the predetermined floor plan (1) not being fully worked through and the catalogue (3, 3a-3c) not containing any further patterns (33a-33c) not yet searched for in the predetermined floor plan (1),
it is checked (180) whether at least one area (1a) of the floor plan (1) which has not yet been processed contains at least one construction joint (12),
in response to said area (1a) containing at least one construction joint (12), searching (190) said area for patterns (31a-33a) from said catalog (3, 3a-3c) while masking said construction joint (12), and
in response to a pattern (31a-33a) being found (195) in the area (1a), at least one construction joint (12) in the planned floor plan (1) is offset and/or rotated (200a) in such a way that it no longer breaks the pattern (31a-33a) found, and/or a prompt is issued to the user to offset the construction joint (12) in this way (200b).

11. Method (100) according to any one of claims 1 to 10, wherein the formwork plan (2) is converted (240) into an order list (6) for formwork elements by comparison with a list (5) of orderable formwork elements.

12. Method (100) according to claim 11, wherein it is checked (241) whether there is an alternative formwork element to two or more formwork elements in the order list (6) that performs the same function, and in response to there being such an alternative formwork element, it is substituted (242) for the two or more formwork elements previously provided.

13. Method (300) of making a structure comprising the steps of:
a formwork plan (2) produced by the method (100) is provided (310);
a spatial arrangement of formwork elements conforming to the formwork plan (2) is produced (320);
a cavity defined by this spatial arrangement is filled with a concrete (330).

14. Computer program comprising machine-readable instructions which, when executed on a computer, and/or on a mobile device, cause the computer, and/or the mobile device, to perform a method (100) according to any one of claims 1 to 12.
